(19) United States
(12) Patent Application Publication
(10) Pub. No.: US 2010/0109962 A1
(43) Pub. Date: May 6, 2010

(54) Circularly polarized antenna and an electronic device having the circularly polarized antenna

(75) Inventors: Chang-Hsiu Huang, Taipei Hsien (TW); Chieh-Sheng Hsu, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/588,380

(22) Filed: Oct. 14, 2009

(30) Foreign Application Priority Data
Nov. 4, 2008 (TW) 097142535

(51) Int. Cl. H01Q 13/10; H01Q 1/38

(52) U.S. Cl. 343/770; 343/700 MS

(57) ABSTRACT

A circularly polarized antenna for wireless signal transmission of an electronic device is disclosed. The circularly polarized antenna includes a base board, a grounding layer, a dielectric body, and a radiating patch metal layer. The grounding layer is disposed on the base board. The dielectric body is disposed on the grounding layer. The radiating patch metal layer is disposed on the dielectric body. The radiating patch metal layer includes a first slot and a second slot disposed on opposite sides of the radiating patch metal layer separately and disposed along a first extension line substantially, wherein the first extension line passes through a center of the grounding layer and is parallel to a side of the grounding layer substantially.

### BACKGROUND OF THE INVENTION

1. Field of the Invention

The present invention relates to a circularly polarized antenna, and more particularly, the present invention relates to a circularly polarized antenna for fine tuning a resonant center and an axial ratio center.

2. Description of the Related Art

A circularly polarized antenna for receiving satellite signals has been disclosed in the prior art. Please refer to FIG. 1A. FIG. 1A is an illustration of a circularly polarized antenna of the prior art. The circularly polarized antenna 90 of the prior art comprises a base board 91, a grounding layer 92, a dielectric body 93, a radiating patch metal layer 94, a feeding line 95, a feeding point 96, and a screw 97. The grounding layer 92 is disposed on the base board 91. The dielectric body 93 is disposed on the grounding layer 92. The radiating patch metal layer 94 is disposed on the dielectric body 93. A radiating electromagnetic field can be generated by matching the radiating patch metal layer 94 and the grounding layer 92. The feeding line 95 can transmit signal to the antenna 90 via the feed point 96. The screw 97 fixes the grounding layer 92 to the base board 91, wherein there is a specific angle between the grounding layer 92 and the radiating patch metal layer 94.

Generally, the direction of the radiating electromagnetic field will be affected by the dielectric body 93, which is limited in size, and will be oblique to one side. In order to make the radiating electromagnetic field symmetric in all directions, the dielectric body 93 will be rotated. After rotation, there is a specific angle between the grounding layer 92 and the dielectric body 93 (also the radiating patch metal layer 94). On the other hand, in order to prevent interference from the screw 97, the dielectric body 93 will also be rotated. When the grounding layer 92 is in a rectangular shape, the two perpendicular resonant lengths of the circularly polarized antenna 90 will be different. The condition abovementioned will cause the separation between the resonant center and the axial ratio center.

Please refer to FIG. 1B and FIG. 1C for characteristic diagrams of the circularly polarized antenna of the prior art. FIG. 1B is an input impedance diagram of the circularly polarized antenna of the prior art. FIG. 1C is a Smith chart of the circularly polarized antenna of the prior art.

FIG. 1B is the input impedance diagram when a signal is reflected out after the feeding line 95 feeds the signal to the circularly polarized antenna 90. A resonant center of the circularly polarized antenna 90 is the smallest frequency in FIG. 1B where the reflection coefficient is at its minimum value and the transmitting energy of the circularly polarized antenna 90 is at its maximum value. The Smith chart in FIG. 1C represents the input impedance of the circularly polarized antenna 90 in a polar coordinate system, which looks like a heart shape. The center of the heart shape is an axial ratio center of the circularly polarized antenna 90. The axial ratio center represents the frequency when the circularly polarized antenna 90 has the best circularly polarized characteristic. The axial ratio is close to 1 or 0 dB, and the antenna has the best polarized characteristic then, wherein the polarization is a relationship between the space and time of the electromagnetic field of the antenna. An antenna generally has horizontal polarization and vertical polarization, and these two polarizations are independent of each other. Alternatively, the antenna may have left-hand circular polarization and right-hand circular polarization, and these two polarizations are also independent of each other. Antennas with the same polarization can transmit the greatest amount of energy. Therefore, the circularly polarized antenna 90 cannot transmit wireless signals effectively if it has bad polarization.

If the resonant center and the axial ratio center are at the same frequency, the circularly polarized antenna 90 has the best polarization and can transmit the greatest amount of energy. In other words, the circularly polarized antenna 90 has the best performance then. In the prior art, the resonant center of the circularly polarized antenna 90 is 2.329 GHz, and the axial ratio center of the circularly polarized antenna 90 is 2.345 GHz. There is a 16 MHz shift between these two centers. The circularly polarized antenna 90 cannot have the best performance because of the frequency shift between these two centers.

In addition, it will increase cost and manufacture time if the dielectric body 93 is designed to match the shape of the grounding layer 92.

Therefore, a new circularly polarized antenna is needed to solve the problems of the prior art.

### SUMMARY OF THE INVENTION

It is therefore an object of the present invention to provide a circularly polarized antenna for tuning a resonant center and an axial ratio center.

It is another object of the present invention to provide an electronic device having a circularly polarized antenna.

In order to achieve the object mentioned above, an electronic device of the invention comprises a wireless module and a circularly polarized antenna electrically connected to the wireless module. The circularly polarized antenna comprises a base board, a grounding layer, a dielectric body, and a radiating patch metal layer. The grounding layer is disposed on the base board. The dielectric body is disposed on the grounding layer. The radiating patch metal layer is disposed on the dielectric body. The radiating patch metal layer comprises a first slot and a second slot disposed on opposite sides of the radiating patch metal layer separately and disposed along a first extension line substantially, wherein the first extension line passes through a center of the grounding layer and is parallel to a side of the grounding layer substantially.

Other objects, advantages, and novel features of the present invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1A is an illustration of a circularly polarized antenna of the prior art.

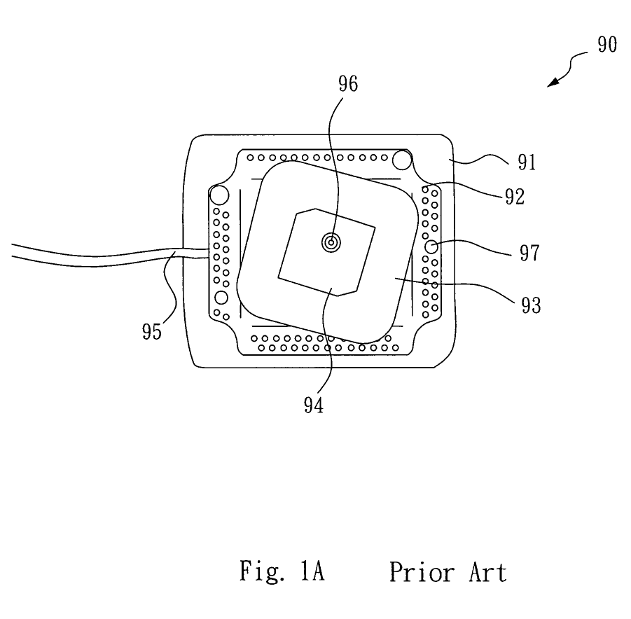

FIG. 1B is an input impedance diagram of the circularly polarized antenna of the prior art.

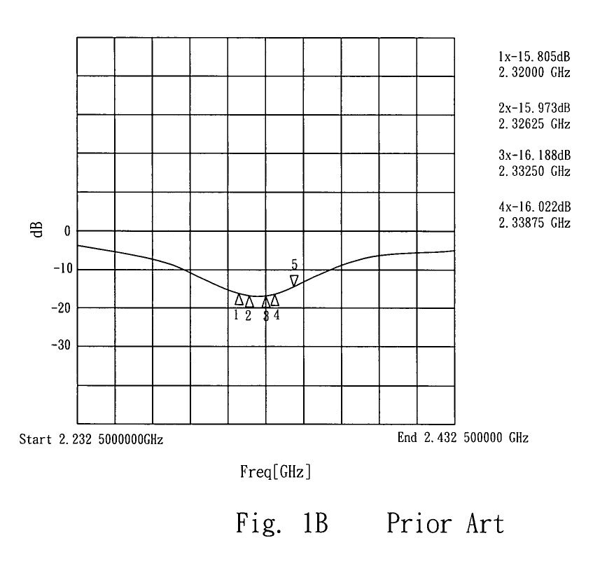

FIG. 1C is a Smith chart of the circularly polarized antenna of the prior art.

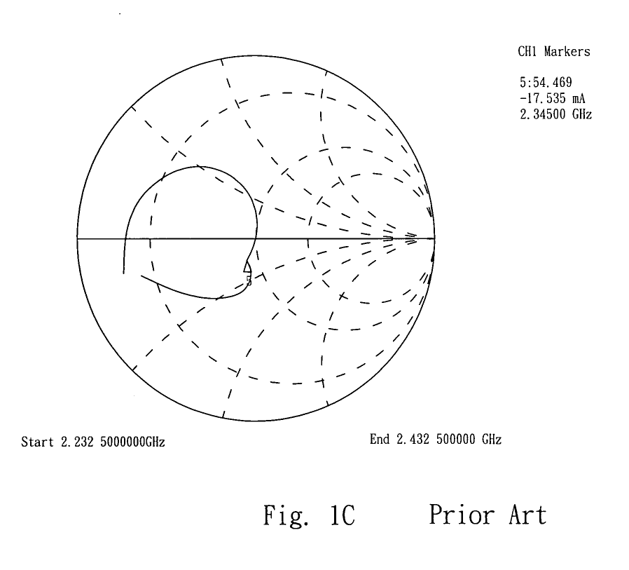

FIG. 2A is an illustration of a circularly polarized antenna of the first embodiment of the invention.

FIG. 2B is an input impedance diagram of the circularly polarized antenna according to the first embodiment of the invention.

FIG. 2C is a Smith chart of the circularly polarized antenna according to the first embodiment of the invention.

FIG. 3A is an illustration of a circularly polarized antenna of the second embodiment of the invention.

FIG. 3B is an input impedance diagram of the circularly polarized antenna according to the second embodiment of the invention.

FIG. 3C is a Smith chart of the circularly polarized antenna according to the second embodiment of the invention.

FIG. 4A is an illustration of a circularly polarized antenna of the third embodiment of the invention.

FIG. 4B is an input impedance diagram of the circularly polarized antenna according to the third embodiment of the invention.

FIG. 4C is a Smith chart of the circularly polarized antenna according to the third embodiment of the invention.

FIG. 5 is a system block diagram of an electronic device of the invention.

### DETAILED DESCRIPTION OF THE PREFERRED EMBODIMENT

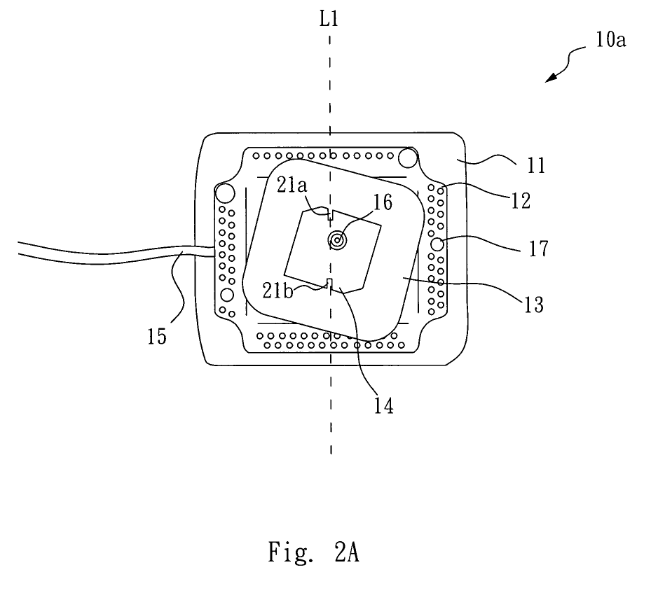

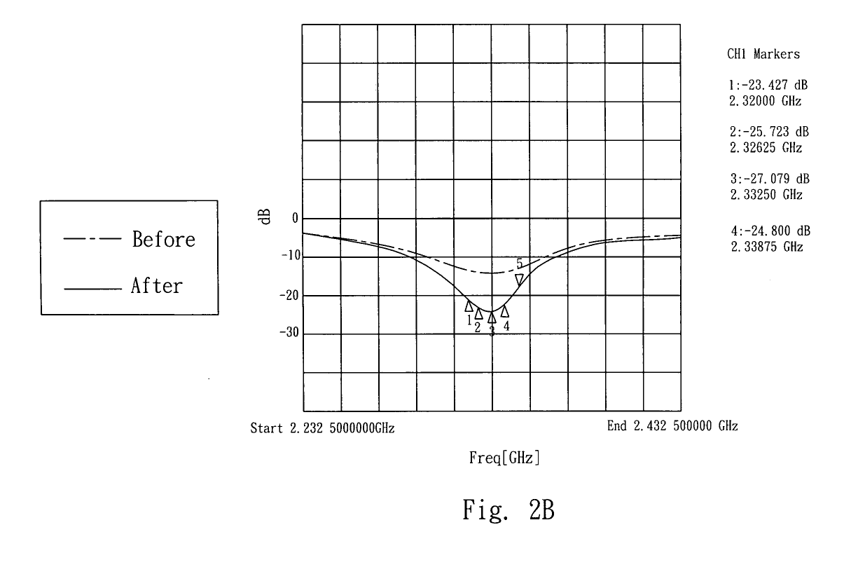

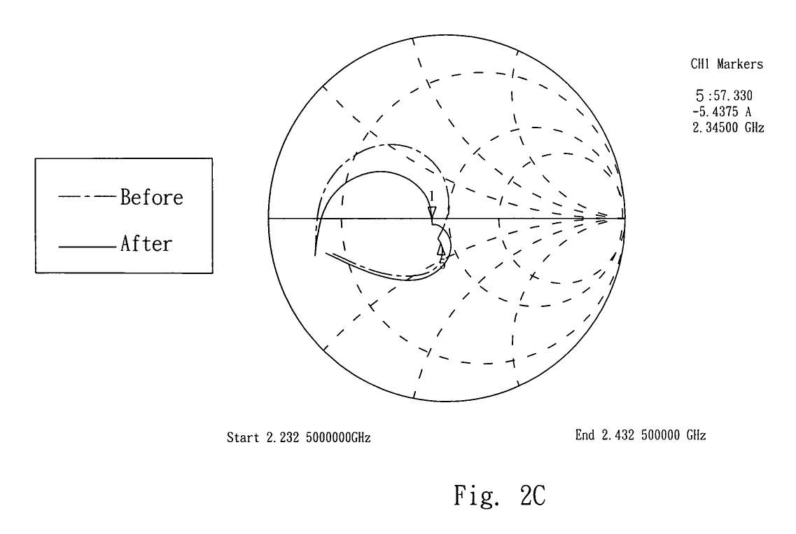

Please refer to FIG. 2A. FIG. 2A is an illustration of a circularly polarized antenna of the first embodiment of the invention.

In the first embodiment of the invention, the circularly polarized antenna 10a comprises a base board 11, a grounding layer 12, a dielectric body 13, a radiating patch metal layer 14, a feeding line 15, a feeding point 16, and a screw 17. The base board 11 is a metal plate made of aluminum, tin or the like. The grounding layer 12 is a conductive layer of a printed circuit board installed on the base board by the screw 17 or welding. The dielectric body 13, made of ceramic or other dielectric material, is disposed on the grounding layer 12. The radiating patch metal layer 14, made of copper, silver, or gold, is disposed on the dielectric body 13. A radiating electromagnetic field can be generated to transmit wireless signals by matching the radiating patch metal layer 14 and the grounding layer 12. The feeding line 15 is electrically connected to the grounding layer 12 for feeding an electric signal to an antenna 10 via the feeding point 16. The feeding line 15 can be but is not limited to an RF cable. The screw 17 fixes the grounding layer 12 to the base board 11.

In order to make the electromagnetic field of the circularly polarized antenna 10a symmetric in all directions or correspond to the shapes of the grounding layer 12 and the dielectric body 13, there is a specific angle between the grounding layer 12 and the dielectric body 13 (also the radiating patch metal layer 14).

The radiating patch metal layer 14 comprises a first slot 21a and a second slot 21b disposed on opposites sides of the radiating patch metal layer 14 separately and disposed along a first extension line L1 substantially. The direction of the first slot 21a and the second slot 21b is parallel to the first extension line L1 substantially, wherein the first extension line L1 passes through a center of the grounding layer 12 and is parallel to a side of the grounding layer 12 substantially. The resonant frequency of the circularly polarized antenna 10a can be fine tuned by the first slot 21a and the second slot 21b to make the resonant center close to the axial ratio center.

Please refer to FIG. 2B and FIG. 2C. FIG. 2B is an input impedance diagram of the circularly polarized antenna according to the first embodiment of the invention. FIG. 2C is a Smith chart of the circularly polarized antenna according to the first embodiment of the invention.

As shown in FIG. 2B and FIG. 2C, before fine tuning, the resonant center and the axial ratio center of the circularly polarized antenna 10a (without the first slot 21a and the second slot 21b) are 2.329 GHz and 2.345 GHz respectively. There is a 16 MHz shift between these two centers. After fine tuning by the first slot 21a and the second slot 21b, both the resonant center and the axial ratio center of the circularly polarized antenna 10a are around 2.3325 GHz; therefore, the circularly polarized antenna 10a has better performance after fine tuning.

More particularly, the use of tuning by the first slot 21a and the second slot 21b is not limited to the above condition. If the grounding layer 12 is in a rectangular shape or other unsymmetrical shape such that two perpendicular resonant lengths of the circularly polarized antenna 10a are different, it will cause a shift between the resonant center and the axial ratio center. The circularly polarized antenna 10a can be fine tuned by the first slot 21a and the second slot 21b under such conditions.

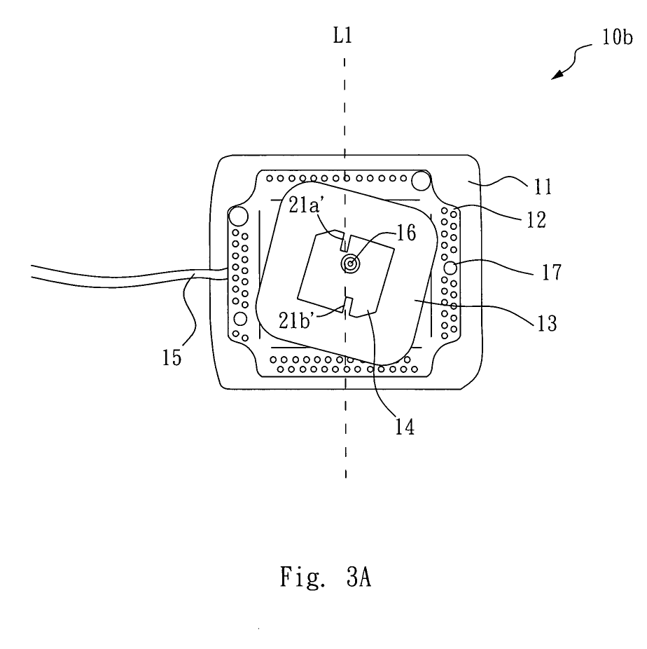

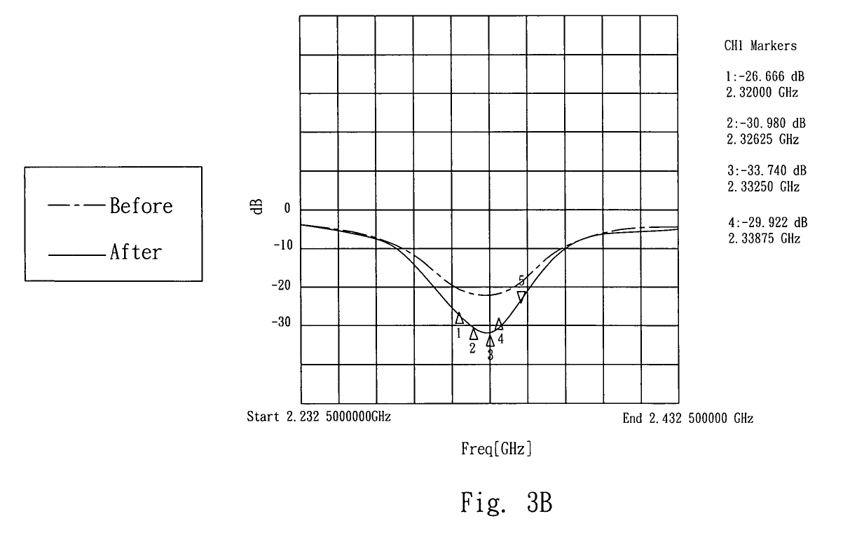

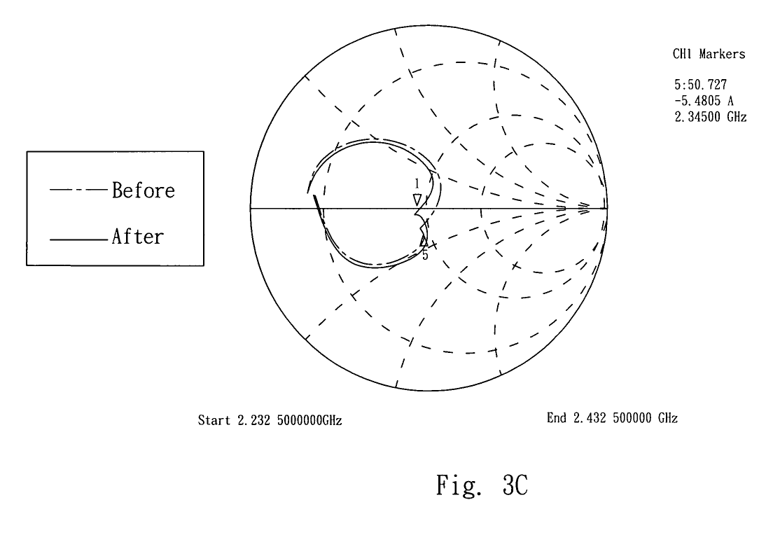

The first slot 21a and the second slot 21b are not limited by the above description. Please refer to FIG. 3A. FIG. 3A is an illustration of a circularly polarized antenna of the second embodiment of the invention.

In contrast to the circularly polarized antenna 10a, both the first slot 21a′ and the second slot 21b′ of the circularly polarized antenna 10b of the second embodiment of the invention are also disposed along the first extension line L1 substantially, but the direction of the first slot 21a′ and the second slot 21b′ is perpendicular to the disposed sides of the radiating patch metal layer 14 substantially.

The characteristics of the circularly polarized antenna 10b are shown in FIG. 3B and FIG. 3C. FIG. 3B is an input impedance diagram of the circularly polarized antenna according to the second embodiment of the invention. FIG. 3C is a Smith chart of the circularly polarized antenna according to the second embodiment of the invention

As shown in FIG. 3B and FIG. 3C, before fine tuning, the resonant center and the axial ratio center of the circularly polarized antenna 10b are 2.329 GHz and 2.33875 GHz, respectively. There is a 9.75 MHz shift between these two centers. After fine tuning by the first slot 21a′ and the second slot 21b′, both the resonant center and the axial ratio center of the circularly polarized antenna 10b are around 2.3325 GHz; therefore, the circularly polarized antenna 10b has better performance after fine tuning.

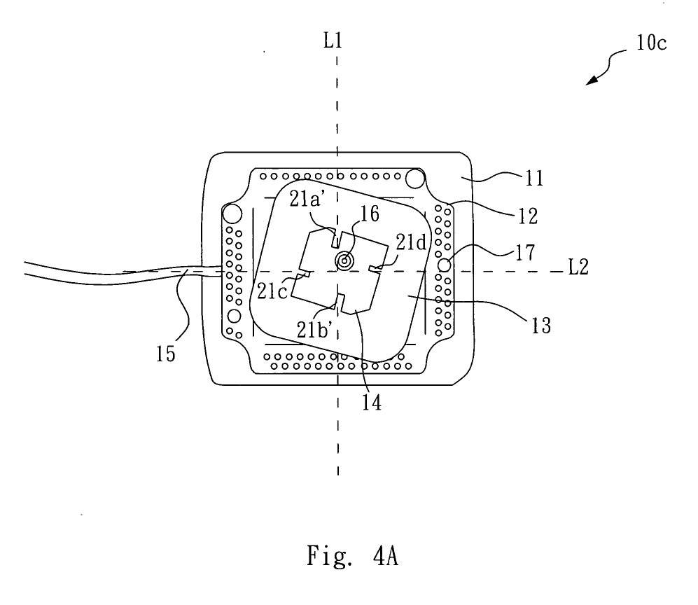

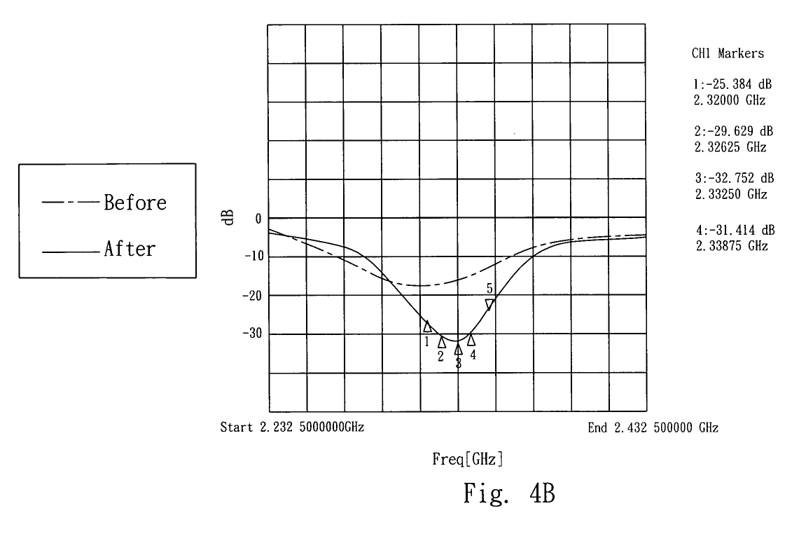

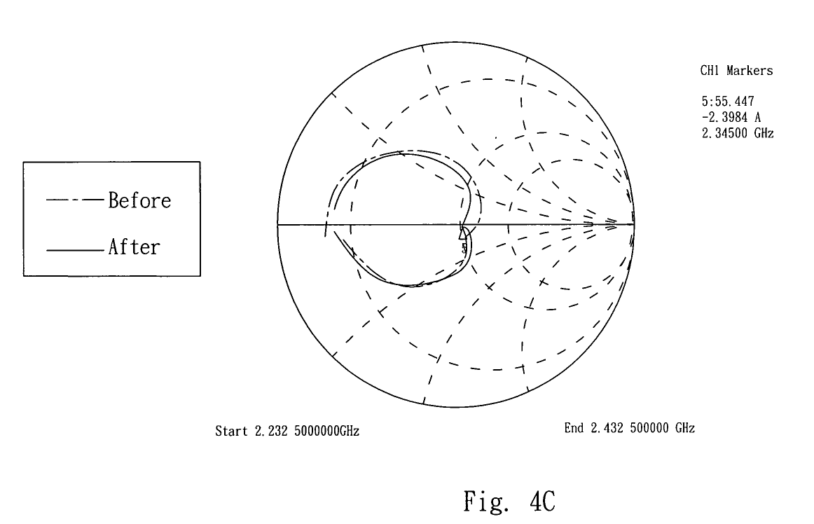

Please refer to FIG. 4A. FIG. 4A is an illustration of a circularly polarized antenna of the third embodiment of the invention.

In the third embodiment of the invention, when the first slot 21a′ and the second slot 21b′ of the circularly polarized antenna 10c are too deep, the resonant center and the axial ratio center of the circularly polarized antenna 10c will be separated again after matching together. Therefore, a third slot 21c and a fourth slot 21d are needed in order to compensate. The third slot 21c and the fourth slot 21d are disposed on opposite sides of the radiating patch metal layer 14 separately and disposed along a second extension line L2 substantially, wherein the second extension line L2 passes through the center of the grounding layer 12 and is perpendicular to the first extension line L1 substantially. The direction of the third slot 21c and the fourth slot 21d is perpendicular to the disposed sides of the radiating patch metal layer 14.

The characteristics of the circularly polarized antenna 10c are shown in FIG. 4B and FIG. 4C. FIG. 4B is an input impedance diagram of the circularly polarized antenna according to the third embodiment of the invention. FIG. 4C is a Smith chart of the circularly polarized antenna according to the third embodiment of the invention

As shown in FIG. 4B and FIG. 4C, before fine tuning, the resonant center and the axial ratio center of the circularly polarized antenna 10c are 2.323 GHz and 2.3325 GHz, respectively. There is a 9.5 MHz shift between these two centers. After fine tuning by the first slot 21a′ and the second slot 21b′, both the resonant center and the axial ratio center of the circularly polarized antenna 10c are close to each other and then separated again. The third slot 21c and the fourth slot 21d are implemented in order to fine tune the resonant center and the axial ratio center of the circularly polarized antenna 10c back to 2.3325 GHz again. Therefore, the circularly polarized antenna 10c can have better performance by the above tuning. The above description explains how to tune the circularly polarized antenna with the slots.

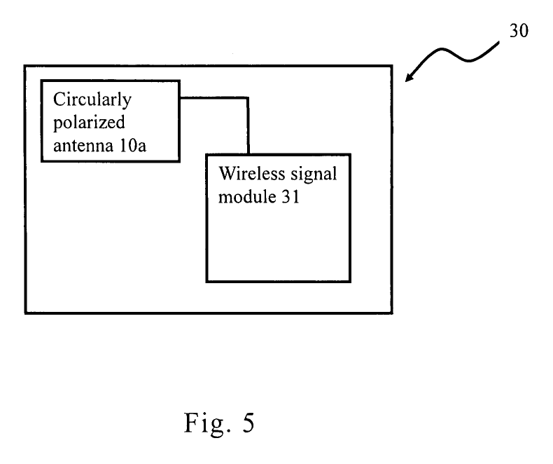

Finally, please refer to FIG. 5. FIG. 5 is a system block diagram of an electronic device of the invention.

In one of the embodiments of the invention, the electronic device 30 can be a GPS (global positioning system) device or the like. As shown in FIG. 5, the electronic device 30 of the invention comprises the circularly polarized antenna 10a and a wireless signal module 31. The electronic device 30 can feed a signal to the circularly polarized antenna 10a via the feeding line 15 (such as an RF cable). The electronic device 30 is electrically connected to the wireless signal module 31 by the feeding line 15 for processing signals (emitting or receiving signals) from the circularly polarized antenna 10a. Therefore, the electronic device 30 can transmit or receive wireless signals by the circularly polarized antenna 10a for wireless communication with other devices (not shown).

Besides the circularly polarized antenna 10a, the electronic device 30 can also use the circularly polarized antenna 10b or the circularly polarized antenna 10c to achieve the same purpose.

Although the present invention has been explained in relation to its preferred embodiments, it is to be understood that many other possible modifications and variations can be made without departing from the spirit and scope of the invention as hereinafter claimed.

What is claimed is:

1. A circularly polarized antenna comprising:
a base board;
a grounding layer disposed on the base board;
a dielectric body disposed on the grounding layer; and
a radiating patch metal layer disposed on the dielectric body, the radiating patch metal layer comprising a first slot and a second slot disposed on opposite sides of the radiating patch metal layer separately and disposed along a first extension line substantially, wherein the first extension line passes through a center of the grounding layer and is parallel to a side of the grounding layer substantially.

2. The circularly polarized antenna as claimed in claim 1, wherein the direction of the first slot and the second slot is parallel to the first extension line substantially.

3. The circularly polarized antenna as claimed in claim 1, wherein the direction of the first slot and the second slot is perpendicular to the disposed sides of the radiating patch metal layer substantially.

4. The circularly polarized antenna as claimed in claim 3, wherein the radiating patch metal layer further comprises a third slot and a fourth slot disposed on opposite sides of the radiating patch metal layer separately and disposed along a second extension line substantially, wherein the second extension line passes through the center of the grounding layer and is perpendicular to the first extension line substantially.

5. The circularly polarized antenna as claimed in claim 4, wherein the direction of the third slot and the fourth slot is perpendicular to the disposed sides of the radiating patch metal layer substantially.

6. The circularly polarized antenna as claimed in claim 1, wherein there is a specific angle between the radiating patch metal layer and the grounding layer.

7. The circularly polarized antenna claimed in claim 1, wherein the grounding layer is in a rectangular shape.

8. The circularly polarized antenna as claimed in claim 1, wherein the dielectric body is made of ceramic material.

9. The circularly polarized antenna as claimed in claim 1 further comprising a screw for fixing the grounding layer to the base board.

10. An electronic device having a circularly polarized antenna and capable of wireless transmission, the electronic device comprising:
a wireless signal module; and
a circularly polarized antenna comprising:
a base board;
a grounding layer disposed on the base board;
a dielectric body disposed on the grounding layer; and
a radiating patch metal layer disposed on the dielectric body, the radiating patch metal layer comprising a first slot and a second slot disposed on opposite sides of the radiating patch metal layer separately and disposed along a first extension line substantially, wherein the first extension line passes through a center of the grounding layer and is parallel to a side of the grounding layer substantially.

11. The electronic device having a circularly polarized antenna as claimed in claim 10, wherein the direction of the first slot and the second slot is parallel to the first extension line substantially.

12. The electronic device having a circularly polarized antenna as claimed in claim 10, wherein the direction of the first slot and the second slot is perpendicular to the disposed sides of the radiating patch metal layer substantially.

13. The electronic device having a circularly polarized antenna as claimed in claim 12, wherein the radiating patch metal layer further comprises a third slot and a fourth slot disposed on opposite sides of the radiating patch metal layer separately and disposed along a second extension line substantially, wherein the second extension line passes through the center of the grounding layer and is perpendicular to the first extension line substantially.

14. The electronic device having a circularly polarized antenna as claimed in claim 13, wherein the direction of the third slot and the fourth slot is perpendicular to the disposed sides of the radiating patch metal layer substantially.

15. The electronic device having a circularly polarized antenna as claimed in claim 10, wherein there is a specific angle between the radiating patch metal layer and the grounding layer.

16. The electronic device having a circularly polarized antenna claimed in claim 10, wherein the grounding layer is in a rectangular shape.

17. The electronic device having a circularly polarized antenna as claimed in claim 10, wherein the dielectric body is made of ceramic material.

18. The electronic device having a circularly polarized antenna as claimed in claim 10 further comprising a screw for fixing the grounding layer to the base board.
